(19) United States
(12) Patent Application Publication
(10) Pub. No.: US 2008/0306717 A1
(43) Pub. Date: Dec. 11, 2008

(54) COOPERATIVE SIMULATION SYSTEM

(75) Inventors: Hiroki KOBAYASHI, Kawasaki (JP); Jun Igarashi, Kawasaki (JP); Nobuhiko Nakamura, Tokyo (JP); Masachika Taguchi, Kawasaki (JP)

Correspondence Address: STAAS & HALSEY LLP, SUITE 700, 1201 NEW YORK AVENUE, N.W., WASHINGTON, DC, 20005, US

(73) Assignees: Fujitsu Limited, Kawasaki (JP); Fujitsu Electronics Inc., Tokyo (JP)

(21) Appl. No.: 12/051,914

(22) Filed: Mar. 20, 2008

(30) Foreign Application Priority Data
Mar. 30, 2007 (JP) 2007-092722

(51) Int. Cl. G06G 7/48

(52) U.S. Cl. 703/6

(57) ABSTRACT

A program cooperative system (cooperative simulation system), including a number of application programs, can easily modify the combination of application programs to be used according to purpose and realizes excellent throughput by comprising a database memory server memorizing and relaying data; a plurality of simulation tools each of which includes a cooperative module for writing data into and reading data from the database memory server; and a administrating unit setting the database memory server and the plurality of simulation tools and administrating operations performed by the database memory server and the plurality of simulation tools, wherein simulation is executed by the plurality of simulation tools in cooperation with one another. Consequently, the cooperation can be established at the same speed as a memory access speed.

### BACKGROUND OF THE INVENTION

1. Field of the Invention

The present invention relates to a cooperative simulation system, and more particularly directs to a configuration of a cooperative simulation system in which a number of simulators and development tool cooperate with one another at a high speed.

2. Description of the Related Art

The mechanical parts of the flasher, the windows, and the doors of vehicle, a copier, and a printer are controlled by microcomputer. Such a device consists of a mechanical part that is a normal control object and a controller formed by a microcomputer board including firm software (firmware). In the development of such a device, a functional test, called a system test, on the device in the state of a product takes the maximum number of processes.

Here, FIG. 1 schematically shows development processes of mechanical part 1 and controller 5. Mechanical part 1 is developed by sequentially undergoing, for example, abstract model (or formula/numeric-value model) design 2, virtual prototype design 3, and creation of actual device 4. Controller 5 is developed by sequentially undergoing, for example, model design 6, code design 7, and creation of actual device (MPU: Micro Processing Unit) 8.

However, if the interface of development of mechanical part 1 does not coincide with that of controller 5 because, for example, the two development are in different stages, it is impossible to carry out a system test by cooperating mechanical part 1 with controller 5. In addition, even if the two development are in the same stage, nonconformity of the interfaces makes it impossible to carry out a system test in which the two development cooperative with each other. Further, since interfaces in different development stages do not comply with each other, a system test in which, for example, virtual prototype design 3 of mechanical part 1 cooperates with model design 6 of controller 5 cannot be accomplished. In order to complete such a cooperative system test, a system is required in which each development stage has a suitable interface.

For example, Japanese Patent Application Laid-Open Publication No. 1999-327956 discloses a conventional program cooperative system which cooperates a number of application programs which carry out independent processes with one another by being interposed by an intermediate interface including a synchronization processor, a connector, and an external interface. In this case, the external interface directly communicates with each individual application program. However, such a system has a fixed configuration, so the external interface can function only in a predetermined system.

As a consequence, the lack of degree of freedom in the system configuration normally does not accomplish the system test unless final actual devices 4 and 8 of mechanical part 1 and controller 5 complete. In other words, even if one actual device completes earlier, the system test takes place after the other actual device completes. For this reason, if an erroneous requirement or algorithm is found in the last stage, the development greatly falls back, resulting in development delay.

As described above, in formation of a single system by cooperating a number of application programs with one another, the usage versatility and the convenience of the system can be enhanced if the system has a configuration with a degree of freedom. The conventional technique described above however requires a new intermediate interface for each system configuration, and the user cannot flexibly modify the system configuration.

As a solution, Japanese Patent Application Laid-Open Publication No. 2005-339029 discloses a program cooperative system in which a number of application programs are used in combination and in which a combination of application programs to be used can be easily varied according to purpose.

In the technique disclosed in Patent Reference 2, communication among application programs is performed by means of interprocess communication, which is low in communication rate and consequently lowers the throughput of the cooperative system. Interprocess communication obstructs rapid development of a device particularly in a system complex in configuration. In addition, the synchronization intervals of application programs do not always coincide.

### SUMMARY OF THE INVENTION

In accordance with an aspect of an embodiment, a cooperative simulation system includes a database memory server memorizing and relaying data, a plurality of simulation tools each of which includes a cooperative module for writing data into and reading data from said database memory server, and a administrating unit setting said database memory server and the plurality of simulation tools and administrating operations performed by said database memory server and the plurality of simulation tools. The simulation is executed by the plurality of simulation tools in cooperation with one another.

### BRIEF DESCRIPTION OF THE DRAWINGS

FIG. 1 is a diagram schematically showing development procedure of a mechanical part, a controller and a firm software section;

FIG. 2 is a block diagram schematically showing a cooperative simulation system according to a first embodiment of the present invention;

FIG. 3 is a table showing a relationship between a count of a counter and each simulation tool of the cooperative simulation system according to the first embodiment of the present invention;

FIG. 4 is a diagram illustrating a GUI (Graphical User Interface) incorporated in a administrating unit of the cooperative simulation system according to the first embodiment of the present invention;

FIG. 5 is a block diagram schematically showing a cooperative simulation system according to a second embodiment of the present invention;

FIG. 6 is a block diagram schematically showing a cooperative simulation system according to a third embodiment of the present invention;

FIG. 7 is a block diagram schematically showing a cooperative simulation system according to a fourth embodiment of the present invention; and

FIG. 8 is a diagram showing communication conventionally performed among personal computers.

### DESCRIPTION OF THE PREFERRED EMBODIMENTS

Various preferred embodiments of the present invention will now be described with reference to the accompanying drawings.

### (a) First Embodiment

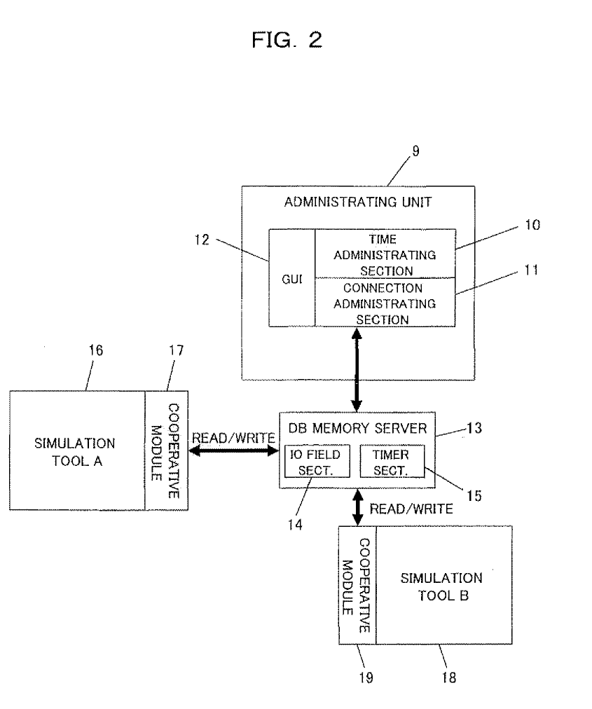

FIG. 2 shows a schematic configuration of a cooperative simulation system according to the first embodiment of the present invention. The cooperative simulation system includes administrating unit 9, database (herein after, denoted by DB) memory server 13, simulation tool A16, and simulation tool B18.

Administrating unit 9 sets DB memory server 13, and simulation tool A16 and simulation tool B18 (herein after, these tools are referred to as simulation tools A16 and B18 as required), and administrates (manages) operations performed by DB memory server 13, simulation tools A16 and B18. Specifically, administrating unit 9 includes time administrating section 10 for administrating time setting in relation to simulation tools A16 and B18, which are synchronization intervals of simulation tools A16 and B18 in timer section 15 described below and a minimum synchronization interval of counters described below that are; connection administrating section 11 for administrating (managing) connection of simulation tools A16 and B18 to an IO (Input Output) field; and a GUI (Graphical User Interface) 12 for improving operability.

DB memory server 13 includes IO field section 14 for memorizing variables used for simulation, and timer section 15 memorizes (retains) information used for synchronization of simulation, such as counts, a time elapsed and/or a sampling time. In addition, simulation tools A16 and B18 include cooperative modules 17 and 19, respectively.

Here, simulation tools A16 and corresponding cooperative module 17, and simulation tool B18 and corresponding cooperative module 19 operate in respective different processes of simulation tools A16 and 318. Exchanging data between each of cooperative modules 17 and 19 and DB memory server 13 carries out simulation. Cooperative modules 17 and 19 can control performance, such as start, stop, and reset, of simulation tools A16 and B18 with reference to control variables memorized in DB memory server 13, in addition to signal transmission/reception and synchronization controlling.

Simulation tools A16 and B18 execute simulation based on time or cycles, and can take the form of software applications or hardware exemplified by emulation tools of ICEs (In-Circuit Emulators) or test boards.

In the present invention, IO field section 14 is formed by records, one for each signal to be transmitted, including a signal type and a signal value. Each record on the IO field can be accessed from a number of cooperative modules and can transmit signals in the ratio of m inputs to n outputs (m:n). Accordingly, since no communication occurs in the system, which makes the system possible to start the operation earlier than conventional systems.

Timer section 15 in DB memory server 13 has two counters (not shown), corresponding one to each of simulation tools A16 and B18. The greatest common divisor of synchronization intervals of simulation tools A16 and B18 is used as the minimum synchronization interval (a virtual synchronization interval, herein after called the minimum sampling interval) of the two counters (i.e., DE memory server 13). In the event of simulation execution, counters in timer section 15 of DB memory server 13 corresponding one to each of simulation tools A16 and B18 increase the counts by one (+1) per the minimum sampling interval. When the count of each counter become the quotient (a common multiple) the synchronization interval of the corresponding simulation tool A16 or B18 divided by the minimum sampling interval, the counter synchronizes with the corresponding simulation tool A16 or B18 and resets the counter to 0 (zero).

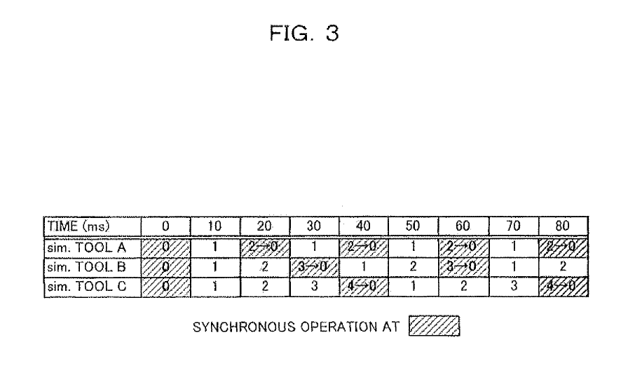

For example, a cooperative simulation system is assumed to include three simulation tools A, B, and C (denoted by “SIM. TOOL” in the drawing) synchronization intervals of which are 20 ms, 30 ms, and 40 ms, respectively, as shown in FIG. 3. The greatest common divisor 10 ms of these intervals is the minimum sampling interval. At the time 0 ms, the count of the counters corresponding to each of simulation tools A, B, and C is 0, and at the ensuing time 10 ms, the count of each counter is increased by +1 and thereby becomes +1. The count of each counter is further increased by +1 at time 20 ms, which makes the counts of simulation tools B and C to be +1 but the counts of the simulation tool A to be 0. Each of simulation tools synchronizes with other simulation tools in the above manner. Alternatively, the common multiple may be set to be the initial value of the counts, which are decreased by 1 (i.e., −1) and when the counter becomes 0, the simulation tool may synchronize with other simulation tool and the count may be return to be the initial value.

If cooperative modules 17 and 19 communicates with DB memory server 13 by means of signals requiring transmission of history of communication, cooperative modules 17 and 19 memorize a number of writing data pieces and data output times of the corresponding simulation tools A16 and B18, respectively, and write the data pieces and the data output times into IO field section 14 at the time of synchronization of simulation tools A16 and B18 with the corresponding counters detailed with reference to FIG. 3.

In other words, if the signals are variables for, such as, serial communication, in which the entire history of the communication need to be transmitted, a number of writing processes to be performed by simulation tools A16 and B18 may be memorized in the form of database write event lists in cooperative modules 17 and 19, respectively, until a synchronization time, and the writing processes into IO field section 14 may be carried out. Into the lists, the times that the writing processes have been performed by simulation tools A16 and B18 may be recorded. The variables are memorized also in the database in the form of lists and are read sequentially or in a lump when reading.

That consequently can transmit signals without being lost even if the signals are pulse-motor signals requiring frequency information about variation in value from the current value at that time or serial network signals. In the case where a number of inputs of the serial signals are written into a single record of IO field section 14, the signals are sort in the chronological order when being written or read, and are read irrespective of signal order at the time of reading.

Cooperative modules 17 and 19 comply with both pull type and push type. Simulation tools (applications) are classified into two types: the pull type (event-driven type) in which an interrupting event causes to write or read a signal; and the push type in which a simulation tool pushes a signal designated at the time of synchronization. Consequently, cooperative modules 17 and 19 can synchronize with the most of simulation tools because cooperative modules 17 and 19 conform to the above two types.

Either simulation tool A16 or B18 serves as an execution controlling tool which controls execution of simulation and which carries out, on the basis of a described script or list, an execution and a halt of simulation and reading/writing operations with respect to IO field section 14 at a particular time or on a particular condition. Further, such an execution controlling tool judges validity of the result of a simulation verification based on the result of reading data from IO field section 14. An execution controlling tool can be an independent application, or the function of the tool can be included in administrating unit 9.

When verification is to be performed in use of such a cooperative simulation system, repetitious starting and quitting of simulation tools are required, resulting in great complication if the operator carries out by hand. The load caused from simulation operation can be lightened by incorporating a function for each of starting, determining initial settings and quitting of simulation tool A16 and B18 by a single operation into simulation tool A16 or B18 serving as the execution controlling tool or into administrating unit 9 with a function as the execution controlling tool.

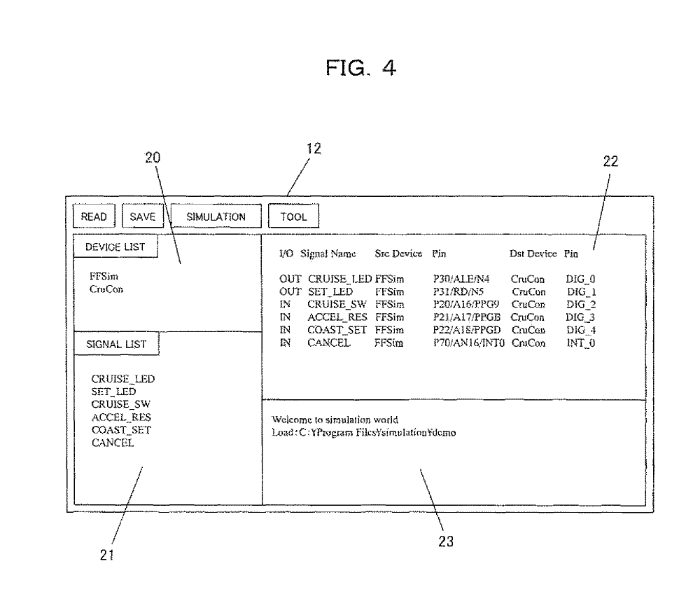

As shown in FIG. 4, administrating unit 9 includes operational GUI 12 having tool administrating window 20, signal administrating window 21, signal connection setting window 22, and message window 23.

Tool administrating window 20 shows a list of simulation tools that are to be used in cooperative simulation. For example, the operator prompts administrating unit 9 to add, delete and set simulation tools to be used in cooperative simulation by adding and deleting a simulation tool displayed on tool administrating window 20 and other operations with an input interface of a keyboard and a mouse (both not shown) connected to administrating unit 9.

Signal administrating window 21 lists names of signals that are to be used in DB memory server 13. The operator causes administrating unit 9 to add, delete, and set signals to be used in DB memory server 13 by adding and deleting signal name displayed on signal administrating window 21 and other operations using the input interface.

Signal connection setting window 22 shows a setting of signal connection of each simulation tool. The operator set signal connection by modifying the contents of signal connection setting window 22 via the input interface. For example, items of “database signal name”, “IN simulation tool”, “tool signal name”, “OUT simulation tool” are displayed on signal connection setting window 22. The operator inputs data into each item, and administrating unit 9 carries out connection setting of signals for each simulation tool.

Message window 23 displays an error message or a status log message thereon.

Here, signal administrating window 21 may also serve as signal connection setting window 22. On signal connection setting window 22, a variable to be connected can be selected from a setting file or a variable list for each simulation tool which list has been obtained from each of cooperative module 17 and 19.

Further, administrating unit 9 (GUI 12) can display a state of signal recording (recording signals) in IO field section 14 on signal administrating window 21 or signal connection setting window 22 (i.e., a monitor (not shown) connected to administrating unit 9). Further, if information about all the signals is displayed all the time, the displaying greatly loads the system, which is solved by displaying value of signals selected. Signals can be expressed by numbers (letter strings) or alternatively by graph.

Administrating unit 9, the above execution controlling tool, or an independent log tool can memorize time history of DB memory server 13. In other words, administrating unit 9, the above execution controlling tool or the independent log tool functions as a memorizing section which memorizes time history of DB memory server 13. This function makes it possible to grasp a state of a signal when an error occurs during verification and to judge the validity of an automatic test. Further, use of the time history as an input to the execution controlling tool reproduces the verification.

As detailed above, the first object of the first embodiment and a second embodiment described below of the present invention is to provide a program cooperative system which includes a number of application programs and in which a combination of application programs to be used can be modified according to purpose with ease, ensuring good throughput. The second object is to provide a system in which application programs different in synchronization interval efficiently cooperate with one another. The third object is to provide a program cooperative system with superior operability.

To attain the above objects, the first embodiment provides a cooperative simulation system comprising: a database memory server 13 memorizing and relaying data; a plurality of simulation tools 16, 18 each of which includes a cooperative module 17, 19 for writing data into and reading data from the database memory server 13; and a administrating unit 9 setting the database memory server 13 and the plurality of simulation tools 16, 18 and administrating operations performed by the database memory server 13 and the plurality of simulation tools 16, 18, wherein simulation is executed by the plurality of simulation tools 16, 18 in cooperation with one another.

Data reading and writing via the database memory server 13 realizes cooperation among a number of simulators or development tools. In addition, the cooperation can be accomplished in the same rate as memory access.

In the cooperative simulation system of the first embodiment of the present invention, the database memory server 13 includes: an IO (Input/Output) field section 14 memorizing one or more variables in relation to the simulation; and a timer section 15 memorizing information for is synchronization of the plurality of simulation tools 16, 18. With this configuration, data can be read or written easily by the simulation tools 16, 18 in synchronization one another.

Additionally, in the cooperative simulation system of the first embodiment, the timer section 15 includes a plurality of counters, corresponding one to each of the plurality of simulation tools 16, 18, and the greatest common divisor of synchronization intervals of the plurality of simulation tools 16, 18 are used as the minimum synchronization interval of the plurality of counters. That causes the plurality of simulation tools different in synchronization intervals to cooperate in synchronization with one another.

Further, in the cooperative simulation system of the first embodiment, if the plurality of cooperative modules 17, 19 are communicated with the data memory server 13 by means of a signal requiring transmission of history of communication, the plurality of cooperative modules 17, 19 retain a number of writing data pieces and data output times of the plurality of simulation tools 16, 18 and the writing data pieces and the data output times are written into the IO field section 14 at the time of synchronization of the plurality of simulation tools 16, 18. With this configuration, the cooperative simulation system can establish communication, such as serial communication, using a signal requiring transmission of history of communication.

Still further, in the cooperative simulation system of the first embodiment, the administrating unit 9 displays a state of signal recording in the IO field section 14 on a monitor, which reduces the load caused from the displaying.

Still further, in the cooperative simulation system of the first embodiment, the administrating unit 9 includes a connection administrating section administrating connection of each of the plurality of simulation tools 16, 18 to the database memory server 13, and a time administrating section 10 administrating time setting relative to synchronization of the plurality of simulation tools 16, 18, which realize efficient process.

Still further, in the cooperative simulation system of the first embodiment, the plurality of cooperative modules 17, 19 supports a pull type in which, when a request for reading or writing a variable in the database is issued, an event is sent to the plurality of cooperative modules 17, 19 to perform the reading or the writing, and a push type in which the plurality of cooperative modules 17, 19 reads or writes a variable in the database at the time of synchronization of the plurality of simulation tools 16, 18. That makes each of the plurality of simulation tools 16, 18 to cooperate with various kinds of simulation tools.

Still further, in the cooperative simulation system of the first embodiment, at least one of the plurality of simulation tools 16, 18 serves as an execution controlling tool controlling execution of the simulation, which realizes an automatic system test.

Still further, in the cooperative simulation system of the first embodiment, execution controlling tool or the administrating unit has a function for each of starting, determining initial settings, and terminating of the plurality of simulation tools 16, 18 used in the simulation with a single operation, so that the load caused by simulation operation can be lightened.

Still further, in the cooperative simulation system of the first embodiment, the administrating unit 9 includes a GUI (Graphical User Interface) 12 having a tool administrating window 20, a signal administrating window 21, a signal connection setting window 22, and a message window 23, which enhances operability of the cooperative simulation system complex in configuration.

Still further, the cooperative simulation system of the first embodiment further comprises a memory memorizing time history of the database memory server 13, which facilitates debugging and enhances the speed of development.

The configuration of the first embodiment of the present invention can modify the combination of application programs according to purposes and can provide a cooperative simulation system with superior throughput.

### (b) Second Embodiment

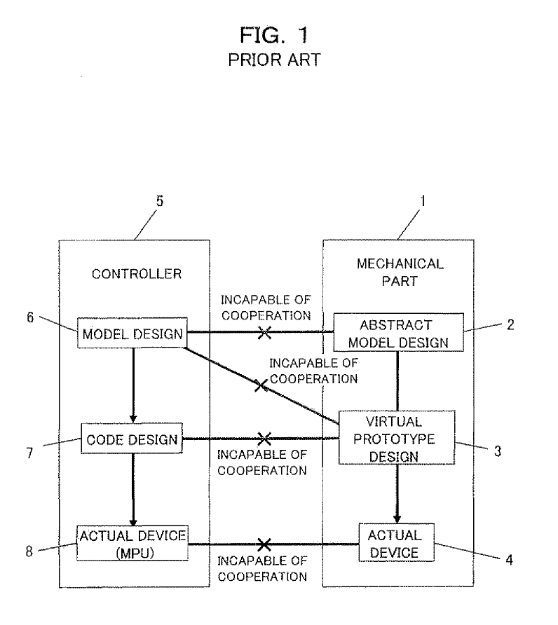

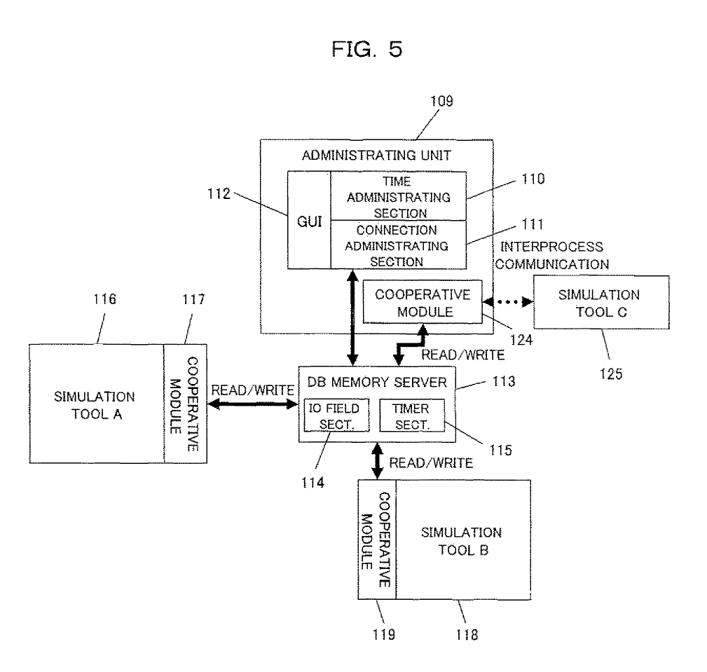

FIG. 5 shows the schematic configuration of a cooperative simulation system according to a second embodiment. The cooperative simulation system of the second embodiment is identical in basic configuration to that of the first embodiment, so only the difference from the first embodiment will be described here. Elements with reference numbers 109-119 in FIG. 5 correspond to elements with reference numbers 9-19 in FIG. 1, respectively.

The cooperative simulation system of the second embodiment has administrating unit 109 equipped with cooperative module 124, which realizes communication with simulation tool C125 capable only of interprocess communication.

Most of the simulators based on time or cycles include external interfaces. If the interfaces are comply with process communication such as Socket or COM but are not a type of reading programs by use of a dynamic library, a cooperative modules cannot operate in the same processes as a (the corresponding) simulation tool. However, in the case where cooperative module 124 is included in administrating unit 109, cooperative module 124 can cooperate with simulation tool C125 by interprocess communication. This mechanism makes cooperative simulation possible even if the cooperative simulation system includes simulation tool C125 equipped with an external interface.

Next, an operation performed in cooperative simulation system of the second embodiment will now be described. For example, simulation tools A116, B118, and C125 are assumed to be simulators of the microcomputer controller, the engine, and the moving mechanism such as accelerator and a brake of a vehicle. In usual practice, these simulation tools A116, B118, and C125 take the form of simulation tools suitable for the simulation objects.

For example, responsive to depression of the accelerator of a vehicle, the program of microcomputer controller adjusts an ignition timing and a fuel supply amount, considering states of the engine speed, the temperature, and others. Here, simulation of the above operation will now be contemplated. Upon depression of the accelerator, simulation tool C125 records “depression of the accelerator” into IO field section 114 of DB memory server 113 via cooperative module 124 by interprocess communication.

Connection administrating section 111 of administrating unit 109 confirms the “depression of the accelerator” with reference to recorded information in IO field section 114, obtains information about states of the engine speed and the temperature, and forwards the obtained information to simulation tool A116 via cooperative module 117.

Simulation tool A116 calculates an ignition timing and a fuel supply amount of the engine based on the received information about the engine, and stores the result of the calculation into IO field section 114 of DB memory server 113 via cooperative module 117.

Connection administrating section 111 of administrating unit 109 confirms the calculation results of the ignition timing and the fuel supply amount based on IO field section 114, and sends the calculation results to simulation tool B118 through cooperative module 119. Simulation tool B118 calculates the engine speed based on the calculation result and conducts simulation.

Here, since the microcomputer controller and the engine simulate operations faster in speed than the moving mechanism, simulation tools A116 and B118 need to simulate variations of several nanoseconds and the simulation intervals are set to be several nanoseconds. Conversely, since the moving mechanism simulates operations lower in speed than the microcomputer controller and the engine, it is sufficient that simulation tool C125 simulates an operation variation as long as several seconds and the synchronization interval of simulation tool C125 are consequently set to be several seconds. Even if a cooperative simulation system a number of simulation tools different in synchronization rate, establishment of synchronization by timer section 115 as described with reference to FIG. 3 carries out efficient simulation at synchronization intervals optimum for each simulation tools. Time administrating section 110 sets synchronization intervals of simulation tools A116, B18, and C125 and the minimum synchronization interval that are used in timer section 115, initializes timer section 115, and increases the count of timer section 115.

As detailed above, simulation can be carried out simulation in the same velocity as the access velocity to the memory and each simulation tool can be establish synchronization at suitable synchronization intervals with simulations performed by the other simulation tools, the cooperative simulation tool of the present invention has superior throughput.

In the cooperative simulation system of the second embodiment, the administrating unit 109 includes a cooperative module 124. With this configuration, if one of the plurality of simulation tools 116, 118 is equipped with an interface capable of reading an external program, reading of a cooperative module to read and write data with respect to the database memory server 113 into the external program can incorporate the plurality of simulation tools 116,118 one another.

### (c) Third Embodiment

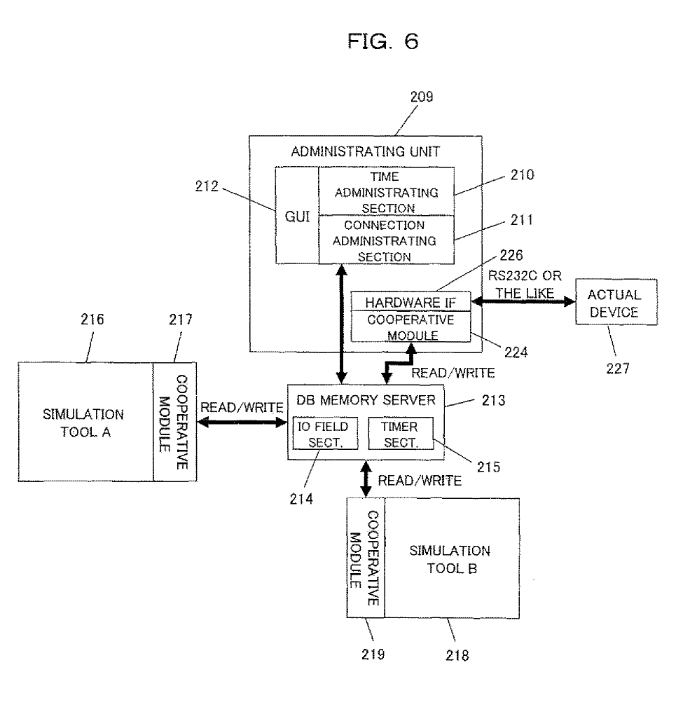

FIG. 6 shows the schematic configuration of a cooperative simulation system according to a third embodiment. The cooperative simulation system of the third embodiment is identical in basic configuration to that of the second embodiment, so only the difference from the first and the second embodiments will be described here. Elements with reference numbers 209-219 in FIG. 6 correspond to elements with reference numbers 9-19 in FIG. 1, respectively.

The simulation system according to the third embodiment includes administrating unit 209 equipped with hardware interface 226 in addition to cooperative module 224, so that each simulation tool can cooperate with not only other simulation tools but also actual device 227.

### (d) Fourth Embodiment

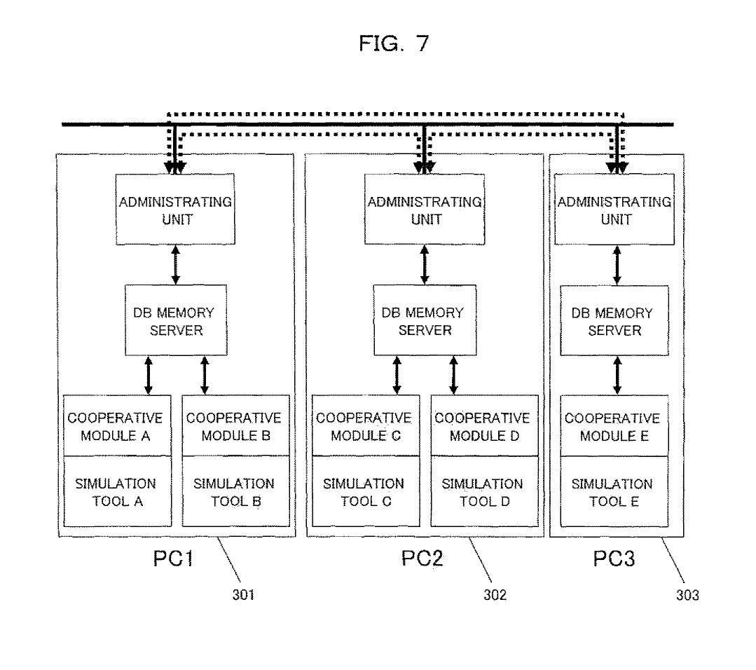

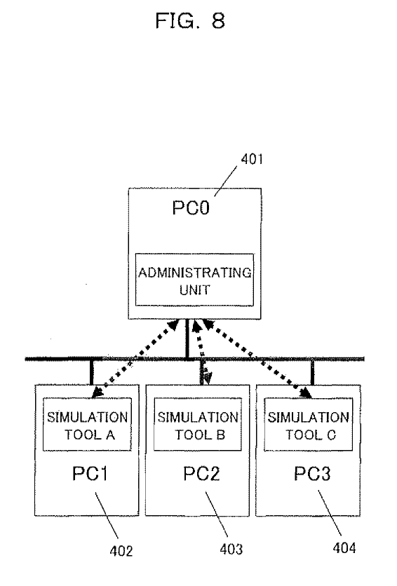

FIG. 7 shows the schematic configuration of a cooperative simulation system according to a fourth embodiment. By way of comparison, FIG. 8 shows conventional communication performed among personal computers. In FIG. 7, the system includes a number of personal computers (PC1, PC2, and PC3) 301, 302, and 303 each of which comprises the administrating unit, the database memory server and the simulation tools, and the administrating units of the personal computers are directly connected to one another by communication among the personal computers, similarly to the first embodiment.

Conversely, in a conventional communication among a number of personal computers, personal computer (PC0) 401 having only a administrating unit communicates with each of personal computers (PC1, PC2, and PC3) 401, 403, and 404 which has only a simulation tool whereby loads caused from a administrating program are concentrated on the administrating unit in personal computer 401 equipped with administrating unit. Comparing the fourth embodiment with the conventional system, the cooperative simulation system according to the present embodiment can reduce collision caused during communication performed by a number of personal computers.

If the administrating unit is formed into a module, the administrating section can be replaced (by another module) according to purposes. For example, the cooperative simulation system of the present invention can be made to comply with an extended network simply by replacing the administrating unit, without requiring replacement of the DB memory server and the cooperative module of each simulation tool.

Further, the present invention should by no means be limited to these foregoing embodiments, and various changes or modifications may be suggested without departing from the gist of the invention.

What is claimed is:

1. A cooperative simulation system comprising:
a database memory server memorizing and relaying data;
a plurality of simulation tools each of which includes a cooperative module for writing data into and reading data from said database memory server; and
an administrating unit setting said database memory server and the plurality of simulation tools and administrating operations performed by said database memory server and the plurality of simulation tools, wherein simulation is executed by the plurality of simulation tools in cooperation with one another.

2. A cooperative simulation system according to claim 1, wherein said database memory server includes:
an IO (Input/Output) field section memorizing one or more variables in relation to the simulation; and
a timer section memorizing information for synchronization of the plurality of simulation tools.

3. A cooperative simulation system according to claim 2, wherein
said timer section includes a plurality of counters, corresponding one to each of the plurality of simulation tools, and
the greatest common divisor of synchronization intervals of the plurality of simulation tools is used as the minimum synchronization interval of the plurality of counters.

4. A cooperative simulation system according to claim 2, wherein,
if the plurality of cooperative modules are communicate with said data memory server by means of a signal requiring transmission of history of communication,
the plurality of cooperative modules memorize a number of writing data pieces and data output times of the plurality of simulation tools, and
the writing data pieces and the data output times are written into said IO field section at the time of synchronization of the plurality of simulation tools.

5. A cooperative simulation system according to claim 2, wherein said administrating unit displays a state of signal recording in said IO field section on a monitor.

6. A cooperative simulation system according to claim 1, wherein said administrating unit includes a connection administrating section administrating connection of each of the plurality of simulation tools to said database memory server, and a time administrating section administrating time setting relative to synchronization of the plurality of simulation tools.

7. A cooperative simulation system according to claim 1, wherein said administrating unit includes a cooperative module.

8. A cooperative simulation system according to claim 1, wherein the plurality of cooperative modules support a pull type in which, when a request for reading or writing a variable in the database is issued, an event is sent to the plurality of cooperative modules to perform the reading or the writing, and a push type in which the plurality of cooperative modules reads or writes a variable in the database at the time of synchronization of the plurality of simulation tools.

9. A cooperative simulation system according to claim 1, wherein at least one of the plurality of simulation tools serves as an execution controlling tool controlling execution of the simulation.

10. A cooperative simulation system according to claim 9, wherein said execution controlling tool or said administrating unit has a function for each of starting, determining initial settings, and terminating of the plurality of simulation tools used in the simulation with a single operation.

11. A cooperative simulation system according to claim 1, wherein said administrating unit includes a GUI (Graphical User Interface) having a tool administrating window, a signal administrating window, a signal connection setting window, and a message window.

12. A cooperative simulation system according to claim 1, further comprising a memory memorizing time history of said database memory server.
